(19) United States
(12) Patent Application Publication
(10) Pub. No.: US 2025/0262661 A1
(43) Pub. Date: Aug. 21, 2025

(54) TUNDISH FLUX FEEDING APPARATUS AND METHOD

(71) Applicant: HarbisonWalker International Holdings, Inc., Pittsburgh, PA (US)

(72) Inventors: Michael David Zinni, Lewiston, NY (US); Alan Urana, Wexford, PA (US)

(73) Assignee: HarbisonWalker International Holdings, Inc., Pittsburgh, PA (US)

(21) Appl. No.: 19/057,511

(22) Filed: Feb. 19, 2025

Related U.S. Application Data
(63) Continuation of application No. PCT/US2025/016230, filed on Feb. 17, 2025.
(60) Provisional application No. 63/555,567, filed on Feb. 20, 2024.
(60) Provisional application No. 63/555,567, filed on Feb. 20, 2024.

(51) Int. Cl. B22D 46/00; B22D 41/00

(52) U.S. Cl. CPC B22D 46/00; B22D 41/00

(57) ABSTRACT

An apparatus for automatically loading flux into a tundish includes a transport having a material conveyor and one or more outlets fluidically coupled to the material conveyor, wherein the material conveyor is configured to transport flux from a storage location to the one or more outlets. At least one sensor is configured to provide data indicative of i) an amount of flux provided to the tundish or ii) insulative properties of a layer of flux in the tundish. A controller is operatively coupled to the at least one sensor and to the transport, where the controller is configured to determine, based on data provided by the sensor, if the tundish requires flux, and if flux is required, control the transport to provide flux to the tundish.

### RELATED APPLICATION DATA

This application claims the benefit of U.S. Provisional Application No. 63/555,567 filed Feb. 20, 2024, and is a continuation of International Application No. PCT/US2025/016230 filed Feb. 17, 2025, each of which is hereby fully incorporated herein by reference.

### FIELD OF THE INVENTION

This present invention relates generally to a continuous casting process for making steel and, more particularly, to a device and method for automatically providing flux to a tundish in a continuous casting process.

### BACKGROUND OF THE INVENTION

In the continuous casting of steel, a tundish is typically used to facilitate the continuous transfer of liquid steel to one or more molds, from a sequence of arriving ladles, each of which carries a batch or ‘heat’ of liquid steel. A tundish is a trough-like vessel lined with refractory material and is designed so as to receive liquid steel from the ladle. A tundish is equipped with one or more outlets that control the flow of the liquid steel exiting the tundish and subsequently entering into one or more casting molds.

During the continuous casting process, molten steel is provided to the tundish and flux is deposited over the molten steel to form an insulating barrier on a top surface of the molten steel. The heat generated by the steel slowly melts the flux into a liquid slag, thinning the insulating layer up to the point, when it must be replenished. This is to avoid the reoxidation of the steel which impacts the quality of the steel. Flux is constituted by a complex mix of oxides, minerals and carbonaceous materials. The main oxides are silica (SiO₂), calcium oxide (CaO), sodium oxide (Na₂O), aluminum oxide (Al₂O₃) and magnesium oxide (MgO). These fluxes, which can be added through access ports arranged in a lid of the tundish, provide multiple functions. More specifically, the flux functions to provide a thermal insulation layer that reduces heat loss from the molten steel, which can cause temperature gradient within the molten steel and uneven casting process. Additionally, the flux absorbs or entraps inclusions in the interface of liquid slag-metal and thus improves the cleanliness of the steel, and also prevents steel reoxidation by contact with the atmosphere, thereby securing the required quality of the steel.

When adding flux to a tundish, current application practice is to manually apply material with 10 kg bags. A drawback to such manual application is the area around the tundish is hazardous. A further drawback is that current practice is sequential and intermittent or sporadic. This results in uneven distribution of the flux, poor insulating conditions, and poor protection against the reoxidation of the steel. Further, startup of the steel making process requires a large application of flux (up to 700 lbs. for the initial cover), and additional material is added each 30-60 minutes in the range of 100-150 lbs, at each ladle change. This requires significant manpower during the initial cover and subsequent maintenance of the flux layer, such labor done in unsafe working conditions.

### SUMMARY OF THE INVENTION

In accordance with the invention, flux is automatically transported from a storage area to one or more locations within a tundish during a metal-making process. In one embodiment, such automatic transport includes continuous transport of flux from the storage area to the one or more locations within the tundish (continuous transport mode). A transport system in accordance with this embodiment of the invention includes a material conveyor, one or more sensors operative to monitor the amount of flux added to the tundish (flux usage rate), and one or more conduits, each of the one or more conduits corresponding to the one or more locations in the tundish.

In another embodiment, such automatic transport includes intermittent transport of flux from the storage area to the one or more locations within the tundish (intermittent transport mode). A transport system in accordance with this embodiment of the invention also includes the aforementioned material conveyor and conduits along with one or more sensors operative to monitor the tundish and provide data indicative of characteristics of flux layer coverage of the liquid steel (e.g., surface scan, or heat loss) in the one or more locations within the tundish.

Optionally, the system may combine features of both embodiments to provide both continuous transport mode and intermittent transport mode, including one or both of a sensor that provides data corresponding to an amount of flux delivered to the tundish, or a sensor that provides data corresponding to a thickness of the flux layer in the tundish.

Regardless of the specific embodiment (continuous or intermittent transport), the transport system also includes a controller that controls delivery of flux to the tundish. The controller may optionally determine where the flux should be delivered in the tundish. The controller commands the transport system to transport the flux from the storage area through the one or more conduits to deliver a desired quantity of flux and/or to deliver the flux to a specified region in the tundish based on data provided by the one or more sensors.

The transport system can vary feed volume by alternating transport feed rates. For example at startup a significant amount of flux material is needed over a period of time. The controller, set for continuous transport mode, can command a higher “continuous” feed rate during startup to ensure sufficient flux coverage. After the initial startup, less flux may be needed and thus the controller can command a lower “continuous” feed rate such that the flux delivered to the tundish corresponds to the flux consumed in the tundish.

When the system is in an intermittent transport mode, the transport can selectively feed flux to one or more locations within the tundish. For example, during intermittent transport mode the controller can command higher feed rates for regions deemed as having significantly lower flux thickness than other regions. In this regard, the controller could selectively feed flux to the one or more locations based on detected hot spots (e.g., based on data from the one or more sensors).

Further, it is noted that the features of the continuous transfer embodiment and the intermittent transfer embodiment may be combined such that a third embodiment includes sensors for related to flux delivery (flux usage) as well as sensors related to flux thickness (hot spots), along with the option to continuously and/or intermittently feed flux into the tundish at fixed and/or variable feed rates.

According to one aspect of the invention, an apparatus for automatically loading flux into a tundish includes: a transport including a material conveyor, wherein the material conveyor is configured to transport flux from a storage location to the tundish; at least one first sensor configured to obtain data indicative of an amount of flux provided to the tundish; and a controller operatively coupled to the at least one first sensor and to the transport, where in a first mode of operation the controller is configured to obtain a target amount of flux to be provided to the tundish; determine an actual amount of flux provided to the tundish based on data obtained by the first sensor, and control the transport to provide flux to the tundish such that the actual amount of flux corresponds to the target amount of flux.

In one embodiment, the at least one first sensor is configured to measure at least one of an amount of flux transported by the material conveyor, or an amount of flux delivered into the tundish.

In one embodiment, the at least one first sensor comprises a strain gauge operative to provide data indicative of a change in flux weight at the flux storage location, and the controller is configured to determine a weight of flux transported by the transport based on the data provided by the at least one first sensor.

In one embodiment, the at least one first sensor comprises a flow sensor operative to provide data indicative of an amount of flux flowing into the tundish, and the controller is configured to determine a weight of flux transported by the material conveyor based on the data provided by the at least one first sensor.

In one embodiment, comprising at least one second sensor configured to obtain data corresponding to a thickness of flux layer in the tundish, where in a second mode of operation the controller is configured to control the transport based on the data corresponding to the flux layer thickness to transport flux to a desired location in the tundish.

In one embodiment, the at least one second sensor comprises a camera.

In one embodiment, the camera comprises a thermal imaging camera.

In one embodiment, the controller is configured to enable or disable the material conveyor.

In one embodiment, the transport comprises a pneumatic transport.

In one embodiment, the material conveyor utilizes a Venturi to transport the flux to the tundish.

In one embodiment, the material conveyor applies pneumatic pressure to transport the flux to the tundish.

In one embodiment, the apparatus further includes a hopper for storing flux, the hopper coupled to the material conveyor.

In one embodiment, the apparatus further includes one or more conduits coupled to the material conveyor, and at least a portion of each of the one or more conduits is flexible to enable a respective one or more conduits to be routed to a target location in the tundish.

In one embodiment, the controller is configured to control the material conveyor to provide a first flow rate of flux to a first region in the tundish and a second flow rate of flux to a second region in the tundish, the second flow rate different from the first flow rate.

In one embodiment, the apparatus further includes a tundish lid for covering the tundish, the tundish lid having at least one feed port integrally formed within the tundish lid, the at least one feed port having an input port for receiving flux from the material conveyor, at least one output port for outputting flux into the tundish, and a conduit fluidically coupling the input port to the at least one output port.

In accordance with another aspect of the invention, a method for automatically providing flux to a tundish during a metal-making process includes: during a first mode of operation determining a target amount of flux to be provided to the tundish; determining an actual amount of flux provided to the tundish; and using a pneumatic transport to deliver the flux to the tundish such that the actual amount of flux corresponds to the target amount of flux.

In one embodiment, using the pneumatic transport to deliver the flux includes at least one continuously delivering the flux to the tundish or intermittently delivering the flus to the tundish.

In one embodiment, the method includes during a second mode of operation determining flux thickness sufficiency on a top surface in the tundish; identifying, based on the flux thickness sufficiency, regions of the top surface of the tundish that have insufficient flux; and automatically transporting flux to the identified regions of the top surface of the tundish.

In one embodiment, determining the flux thickness sufficiency includes determining a rate of heat loss from each of the regions, and concluding regions that are losing heat at a rate above a predetermined threshold have insufficient flux layer thickness.

In one embodiment, determining the flux thickness sufficiency comprises obtaining a heat signature for a top surface of the flux in the tundish and determining the flux thickness sufficiency based on the heat signature.

In one embodiment, obtaining the heat signature comprises obtaining a thermal image of the top surface of the flux through an access port in the tundish.

In one embodiment, identifying includes analyzing the heat signature to quantify heat loss over the top surface of the flux.

In one embodiment, delivering the flux to the tundish includes automatically transporting the flux to a first region at a first flow rate, and automatically transporting the flux to a second region at a second flow rate different from the first flow rate.

In one embodiment, the method includes determining a weight of flux provided to the tundish.

In one embodiment, delivering flux includes pneumatically transporting the flux to the identified regions.

In accordance with another aspect of the invention, an apparatus for automatically loading flux into a tundish includes: a transport including a material conveyor and one or more outlets fluidically coupled to the material conveyor, wherein the material conveyor is configured to transport flux from a storage location to the one or more outlets; at least one sensor configured to provide data indicative of i)_an amount of flux provided to the tundish or ii) insulative properties of a layer of flux in the tundish; and a controller operatively coupled to the at least one sensor and to the transport, where the controller is configured to determine, based on data provided by the sensor, if the tundish requires flux, and if flux is required, control the transport to provide flux to the tundish.

In accordance with another aspect of the invention, a tundish lid for selectively covering a top surface of a tundish includes: a support structure having a first surface, a second surface disposed opposite the first surface, and a at least one side wall joining the first surface to the second surface; at least one feed port including an input port for receiving flux, an output port for outputting flux into the tundish, and a conduit fluidically coupling the input port to the output port, wherein the at least one feed port is at least partially disposed between the first surface, the second surface, and the at least one sidewall.

In one embodiment, the input port opens to the first surface and the output port opens to the second surface.

In one embodiment, the support structure comprises a metal frame and at least one of a wire mesh or metal anchors attached to the metal frame.

In one embodiment, the tundish includes refractory attached to the at least one of the wire mesh or the metal anchors.

Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well-known process operations have not been described in details so as to not unnecessarily obscure the present invention.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a schematic diagram of an exemplary automatic flux feeding system in accordance with an embodiment of the invention.

FIG. 2 is a schematic diagram of an exemplary automatic flux feeding system in accordance with another embodiment of the invention.

FIG. 3 is a perspective view of an exemplary conduit for transporting flux to tundish in accordance with an embodiment of the invention.

FIGS. 4A-4D illustrate a tundish lid including internal piping for transporting flux into the tundish in accordance with an embodiment of the invention.

FIG. 5 is a flow chart illustrating an exemplary method for automatically feeding flux to a tundish in accordance with an embodiment of the invention.

FIG. 6 is a schematic diagram of an exemplary controller for executing the method in accordance with the invention.

### DETAILED DESCRIPTION OF PREFERRED EMBODIMENT

Various aspects of the invention now will be described more fully hereinafter. Such aspects of the invention may, however, be embodied in many different forms and should not be construed as limited to the embodiments set forth herein; rather, these embodiments are provided so that this disclosure will be thorough and complete, and will fully convey its scope to those skilled in the art.

The word “about” when immediately preceding a numerical value means a range of plus or minus 10% of that value, e.g., “about 50” means 45 to 55, “about 25,000” means 22,500 to 27,500, etc., unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein.

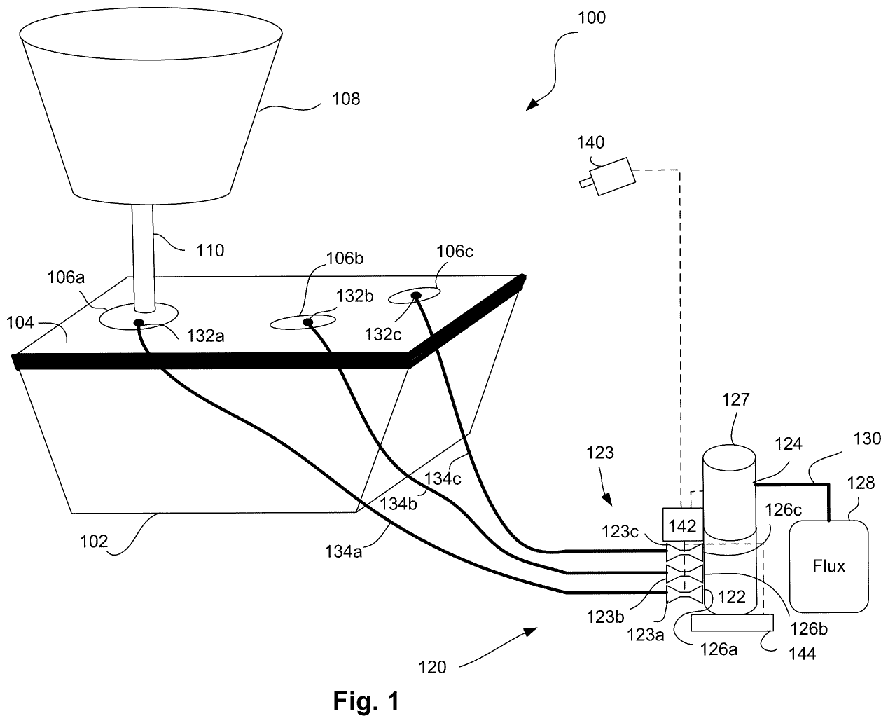

Referring now to FIG. 1, illustrated is an exemplary system 100 for automatically transporting flux to a tundish 102 during a metal-making process. As shown in FIG. 1, the tundish 102 includes a lid 104 having a plurality of access ports 106a, 106b, 106c that provide access into the tundish 102. While only three access ports 106a, 106b, 106c are illustrated, it will be appreciated that more or fewer access ports may be arranged in the lid 104 depending on the needs of the specific application, e.g., based on the size of the tundish.

With continued reference to FIG. 1, molten metal is provided to the tundish 102 through a ladle 108 via a ladle shroud 110 disposed at one of the access ports 106a-106c, e.g., access port 106a. A transport 120 for moving flux into the tundish 102 includes a bin 122 having an input port 124 and one or more output ports 126a, 126b, 126c, where the input port 124 and one or more output ports 126a, 126b, 126c are fluidically coupled to the bin 122. The transport 120 further includes a material conveyor 123 having one or more inputs fluidically coupled to respective ones of the one or more output ports 126a, 126b, 126c. Preferably, the number of output ports 126a, 126b, 126c correspond to the number of access ports 106a, 106b, 106c in the tundish lid 104. One or more outputs of the material conveyor 123 are fluidically connected to respective ones of the access ports 106a, 106b, 106c via conduits 134a, 134b, 134c.

The bin 122 may be pneumatically fed using, for example, a vacuum pump 127, also known as a vacuum conveyor, that pulls the material from the bulk flux storage location 128 (e.g., a flux storage bag or the like) via conduit 130 and keeps the bin full (e.g., a container within the bin housing). In the illustrated embodiment the pump 127 as shown as part of the bin 122, but it should be appreciated that the pump 127 may be separate from the bin and connected thereto via a conduit. The bin 122 may have a sensor to turn the vacuum pump on and off, the sensor located in the bin. In operation, a vacuum created by the vacuum pump 127 pulls flux from the storage location 128 into bin 122 via conduit 130. The material conveyor 123, being fluidically coupled to the bin 122, draws flux from the bin 122 and provides the flux to conduits 134a, 134b, 134c, which deliver the flux to the tundish 102. Preferably, the flux is a granulated flux to reduce the generation of flux dust during the transport process.

In the illustrated embodiment one or more flux outlets 132a, 132b, 132c are arranged at respective ones of the access ports 106a, 106b, 106c, and are fluidically coupled to respective ones of the one or more output ports 126a, 126b, 126c via one or more conduits 134a, 134b, 134c, and the material conveyor 123 (e.g., air Venturi units 123a, 123b, 123c). The number of flux outlets 132a, 132b, 132c can correspond to the number of access ports 106a, 106b, 106c in the tundish lid 104, or can be multiples of the number of access ports, e.g., two flux outlets per access port.

A sensor 140 monitors the tundish 102 and, in particular, the access ports 106a, 106b, 106c in the lid 104 of the tundish 102. The sensor 140 and/or the aforementioned optional weight and flow sensors (discussed in further detail below) may be communicatively coupled to a controller 142 located at the transport 120. While the controller 142 is shown at the transport 120, it may be located elsewhere as needed. The sensor 140 is operative to provide to the controller 142 data indicative of a flux thickness in various regions of the tundish 102. For example, the sensor 140 may be an infrared-based sensor, such as an active infrared sensor that operates at short infrared wavelengths, or a passive infrared sensor that operates at mid to long infrared wavelengths (e.g., a thermal imaging camera). Alternatively or additionally, the sensor 140 may be a conventional camera that obtains color images looking into access ports 106a, 106b, 106c, where different colors represent different flux thickness.

The controller 142 is also communicatively coupled to the bin 122, the vacuum pump 127 and to an air source (not shown) that in turn is fluidically coupled to the material conveyor 123. As discussed in further detail below, the controller 142 is operative to control the vacuum pump 127 to regulate flux level in the bin 122 and control the material conveyor 123 to regulate delivery of flux into the tundish 102. In one embodiment, the controller 142 controls the material conveyor 123 based on data provided by the sensor 140, the weight sensors and/or flow sensors. In this manner, the flux can be selectively transported to a desired access port 106a, 106b, 106c of the tundish lid 104 in a desired manner (i.e., continuously or intermittently) so as to alter an amount of flux in various regions of the tundish 102.

Additionally, the controller 142 may also control the rate at which flux is provided to the tundish 102. For example, the controller 142 may command an air valve that supplies air to the material conveyor 123 to vary a flux transport rate of the material conveyor. In this manner, the flow rate of the flux into the tundish 102 can be controlled. Further, flux flow rates at the respective flux outlets 132a, 132b, 132c may be controlled independent of each other, e.g., via Venturi units 123a, 123b, 123c such that a flux flow rate provided at one flux outlet is different from a flux flow rate provided at another flux outlet. In one embodiment, such control may be closed-loop control based on data provided by the one or more weight sensors, the one or more flow sensors and/or the one or more sensors 140.

A weight sensor 144, such as a load cell having a strain gauge or the like, can be arranged at the bin 122. The weight sensor 144 provides data to the controller 142 indicative of a change in weight of the flux at the bin 122. Controller 142, based on the data from the weight sensor 144, can set the required continuous feed of the flux corresponding to the casting sequence of the caster.

The system may operate in a continuous transport mode or an intermittent transport mode. As used herein, continuous transport is defined as a steady, uninterrupted feed of flux to the tundish. Additionally, intermittent transport is defined as a plurality of separate and distinct feed cycles each spanning a finite time interval and separated by a period feed inactivity.

At the startup, i.e., when a batch of steel is first provided to the tundish, continuous transport mode is preferred in order to quickly deposit a layer of flux over the molten steel (i.e., a large batch addition). For example, the controller 142 may set a higher volume of continuous flux feed during startup to quickly cover the molten steel. Once sufficiently covered, the controller may reduce the feed rate to continuously feed flux at a slower rate that corresponds to flux consumption. In this manner, the flux thickness can be maintained such that the molten steel is always covered by a layer of flux. In one embodiment, the controller 142, based on the data from the weight sensor 144, also can determine and optionally log an amount of flux provided to the tundish 102. Alternatively or additionally, the controller 142 can determine an amount of flux available for transport to the tundish 102 and, if the amount of available flux drops below a specified level, the controller 142 can generate an alarm indicating additional flux should be added to the bin 122 and/or the flux storage location 128.

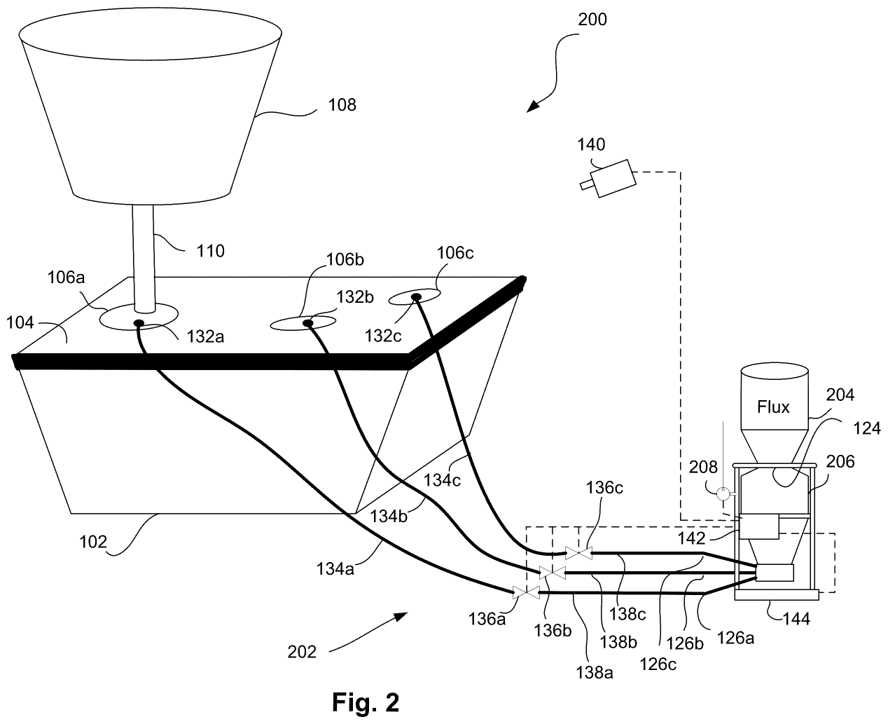

Moving now to FIG. 2, illustrated is another system 200 for automatically transporting flux to a tundish 102 during a metal-making process. The system 200 is similar to the system 100 of FIG. 1 except for the means by which the flux is fed to the tundish 102 and, therefore, only the different features are discussed here. As discussed in further detail below, the system 200 of FIG. 2 utilizes a material conveyor in the form of a pressurized pneumatic transporter. The pressurized pneumatic transport includes chamber with flux stored in the container. The chamber is pressurized to push the material out of the chamber and through the conduits, where the pressure dictates how fast the material leaves the container. Valves open/close each line to enable/inhibit flow. The system 200 of FIG. 2 enables efficient batch filling, e.g., filling the tundish, intermittent larger additions such as 20 kg per hour per conduit. The system 200 also can be blended into a continuous system to match the flux consumption at low rate of flow by using the Venturi pump devices of the system illustrated in FIG. 1. The discussion above with respect to the common features between FIGS. 1 and 2 is also applicable to FIG. 2.

The system 200 of FIG. 2 utilizes a transport 202 having a flux storage area in the form of a hopper 204. The hopper 204, for example, has a rectangular or cylindrical body that tapers at one end to feed a sealable distribution chamber 206, where an input port 124 of the distribution chamber 206 can be selectively opened and closed to enable or inhibit the flow of flux material from the hopper 204 into the distribution chamber 206. A level sensor (not shown), which may be arranged on or within the distribution chamber 206, provides an indication of the amount of flux in the distribution chamber 206. Compressed air is provided to the distribution chamber 206 by a compressed air source, such as compressor 208, and along a bottom region of the distribution chamber 206 output ports 126a, 126b, 126c are coupled to valves 136a, 136b, 136 via conduits 138a, 138b, 138c. It is noted that the valves 136a, 136b, 136c may be located elsewhere from what is shown in FIG. 2. For example, valves 136a, 136b, 136c, may be located at the output ports 126a, 126b, 126c or at the flux outlets 132a, 132b, 132c. Each of the one or more valves 136a, 136b, 136c may optionally include a weight sensor and/or a flow sensor configured to detect an amount of flux flowing through the respective valve. Alternatively, the optional weight and flow sensors may be separate from the valves and located elsewhere. As discussed in further detail below, the valves 136a, 136b, 136c are operative to enable or disable flow through the respective flux outlets 132a, 132b, 132c.

In this embodiment, the pressurized distribution chamber 206 forms a material conveyor. Controller 142 is communicatively coupled to the distribution chamber 206 and level sensor to control operation of the input port 124 as well as operation of the compressor 208 and valves 136a, 136b, 136c so as to maintain a flux level in the distribution chamber 206 provide the flux to the tundish 102.

In operation, controller 142 determines, based on the level sensor, if flux is required in the distribution chamber 206 and if so, the controller commands the input port 124 to open and allow flux to move from the hopper 204 into the distribution chamber 206. Upon sufficient flux being in the distribution chamber 206, the controller 142 closes the input port 124 and commands pressure to be provided by the air compressor 208 to pressurize the distribution chamber 206.

The controller 142 is also communicatively coupled to the valves 136a, 136b, 136c and the optional weight and flow sensors. The controller 142 is operative to selectively change a state of each valve between an open position, a closed position, or an intermediate position, independent of a state of the other valves. In one embodiment, the controller 142 determines which valves to open and close based on data provided by the one or more weight sensors, the one or more flow sensors and/or the one or more sensors 140. In this manner, the flux can be selectively transported to a desired access port 106a, 106b, 106c of the tundish lid 104 in a desired manner (i.e., continuously or intermittently) so as to alter an amount of flux in various regions of the tundish 102.

Additionally, the controller 142 may also control the rate at which flux is provided to the tundish 102. For example, the controller 142 may command a pressure regulator of the compressor 208 to vary a pressure provided to the distribution chamber 206 and/or may control the degree in which the valves are opened (e.g., 10% open, 50% open, 85% open, etc.). In this manner, the flow rate of the flux into the tundish 102 can be controlled. Further, flux flow rates at the respective flux outlets 132a, 132b, 132c may be controlled independent of each other, e.g., via valves 136a, 136b, 136c such that a flux flow rate provided at one flux outlet is different from a flux flow rate provided at another flux outlet. In one embodiment, such control may be closed-loop control based on data provided by the one or more weight sensors, the one or more flow sensors, and/or the one or more sensors 140. Further operational details of the system 200 are described with respect to FIG. 1 and not repeated here.

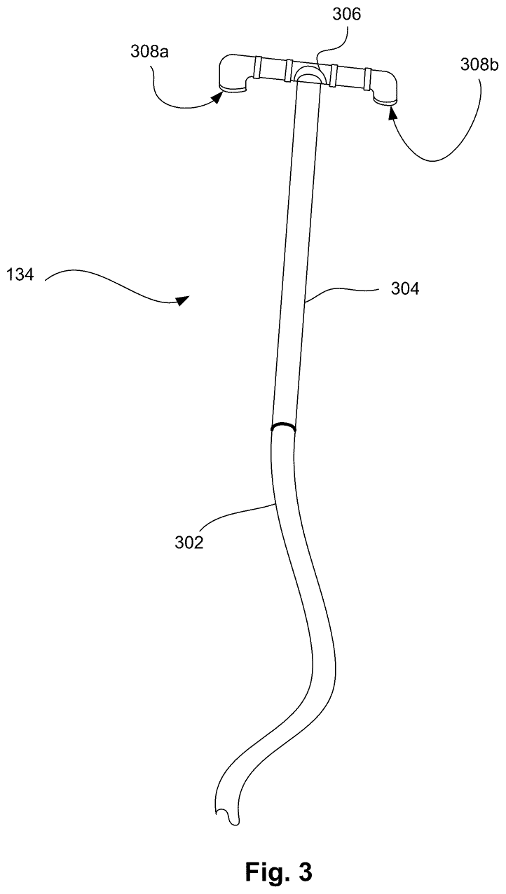

With reference to FIG. 3, illustrated is an exemplary conduit 134 for transporting flux output by a valve 136a, 136b, 136c and into one of the access ports 106a, 106b, 106c of the tundish lid 104. The conduit 134 includes a first flexible portion 302 that is connectable to one of the valves 136a, 136b, 136c. The flexible portion 302, which may be made of conventional industrial hose or other like material, enables the conduit 134 to be easily routed from the transport 120, 202, around any obstacles, and to the tundish lid 104. The length of the flexible portion 302 can be chosen to satisfy the requirements of the specific application.

The conduit 134 further includes a rigid portion 304 coupled to the flexible portion 302. The rigid portion 304 may be formed, for example, from steel pipe or other like materials that can withstand the high temperatures encountered at the tundish access ports 106a, 106b, 106c. In the illustrated embodiment of FIG. 3, the conduit 134 includes a T-fitting 306 connected to the rigid portion 304 to provide a flux output port 132 having two openings 308a, 308b. As will be appreciated, the conduit 134 may be modified to form a flux output port 132 having more or fewer openings as desired. The length of the rigid portion 304 should be sufficient to locate the flexible portion 302 a sufficient distance from the access ports 106a, 106b, 106c such that the flexible portions are not subjected to the high temperatures and harsh environment at the tundish 102. It should be noted that while the exemplary conduit 134 includes a flexible portion and a rigid portion, it may be formed completely of flexible material, provided such flexible material can withstand the harsh environment at the tundish 102. Further, in situations where the transport system 120, 202 is a permanent installation, the conduit 134 may be completely formed from rigid components, e.g., pipe.

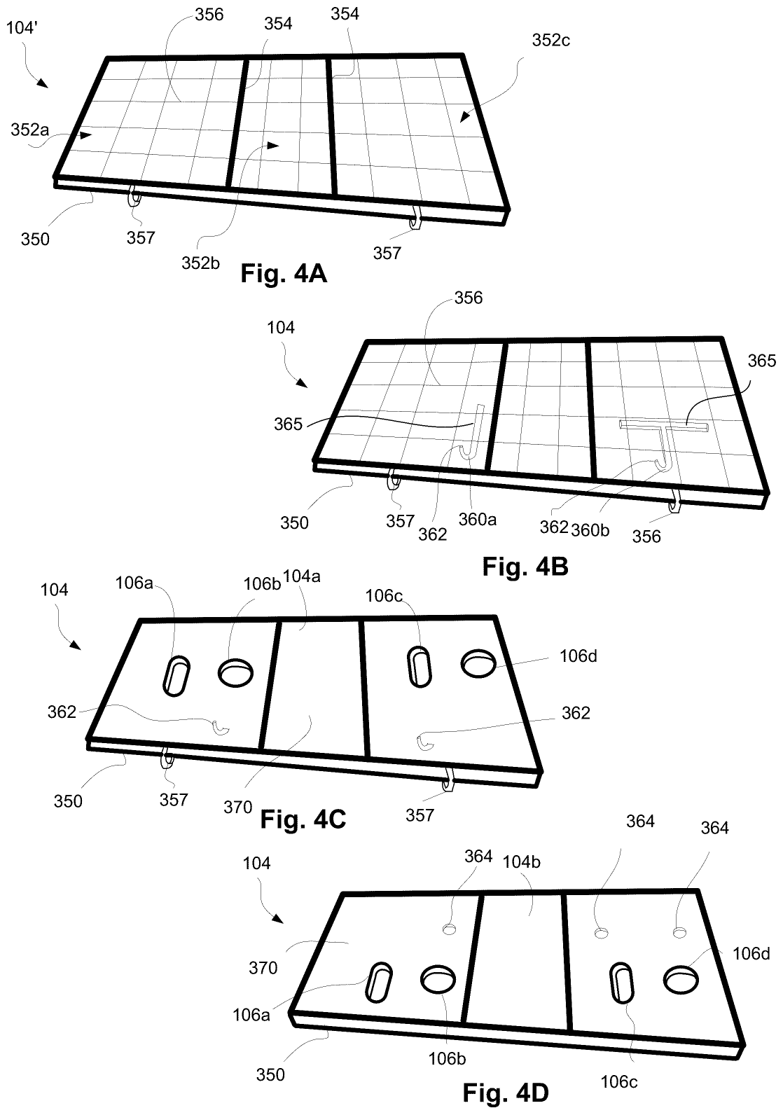

In the above-described embodiments the output ports 308a, 308b as well as all the remaining portions of the conduit 134 are external and separate from the tundish lid 104. In contrast to such configuration, FIGS. 4A-4D illustrate a tundish lid 104′ in accordance with an embodiment of the invention where at least some of the conduit and/or output ports, such as described in FIG. 3, or similar, is/are formed within and/or integral with the tundish lid 104′. More specifically, the output ports and/or parts of the conduit are formed as part of the lid 104′.

Referring to FIG. 4A, illustrated is a partial construction of the tundish lid 104′ in accordance with an embodiment of the invention. The tundish lid 104′ includes a support structure that includes a rectangular frame 350 divided into three section 352a, 352b, 352c by brace sections 354. While three sections are shown in the frame 350, this is merely exemplary and more or fewer sections may be formed in the frame depending on the specific application parameters. The example described in FIG. 4A thru 4D is rectangular, however the tundish lids have many geometrical designs and typically are conforming to the geometry of the top side of the tundish. The geometry of the lid may be a square, parallelogram, trapezoid, oval or combination of such. In some embodiments, the support structure further includes a wire mesh 356 spanning across the three sections 352a, 352b, 352c. While a wire mesh is illustrated, such wire mesh 356 is not typically used for tundish lids that for tundishes that will be subjected to high casting temperatures, where excessive thermal expansion of the wire mesh could be expected. In such cases a series of metal anchors (not shown) is attached or welded to the frame 350 and, or in addition to brace sections 354. The wire mesh 356 is absent in such constructions. As is discussed below with respect to FIGS. 4C and 4D, the wire mesh 356, or series of metal anchors (not shown) provides a mounting means for refractory disposed within the frame 350. Lifters 357 are arranged on the frame 350 to facilitate lifting and positioning, typically by a crane movement, of the tundish lid 104′.

With additional reference to FIG. 4B, arranged in the first section 352a is a first feed port 360a and arranged in the third section 352c is a second feed port 360b. While only two feed ports are illustrated, it will be appreciated that the number of feed ports can be adjusted (i.e., more or fewer in each section) depending on the application parameters. Each feed port 360a, 360b includes an input port 362 for receiving flux output by one or more of the valves 136a, 136b, 136c, and one or more output ports 364 for outputting flux received by the input port. Each input port 362, which is disposed on a cold side of the lid 104′ (i.e., the side of the lid away from the steel) may be angled relative to a surface of the tundish lid 104′ as needed to provide sufficient clearance for lifting and positioning the lid. Input port 362 is shown to be curved, however other geometries could be utilized, such as a straight pipe or angled pipe. The length of the input port is variable and could be few inches or up to a feet long. There may be additional connecting parts and couplings required to connect the input port 362 with the rigid portion 304 or flexible portion 302. Each output port 364 is disposed on a hot side of the tundish lid 104′ (i.e., the side of the lid that faces the steel), best seen in FIG. 4D, and is fluidically coupled to the input port via conduit 365.

In the illustrated embodiment, the feed port 360a arranged in the first section 352a of the tundish lid 104′ has a single output port, while the feed port 360b arranged in the third section 352c of the tundish lid 104′ includes two output ports. As will be appreciated, feed ports also may be configured with three, four or more output ports depending on the application parameters. In addition, more than two feed ports 360, in various configurations, could be applied in larger lids, or more complex lids which are confirming to large size or more complex tundish geometries.

With additional reference to FIGS. 4C and 4D, illustrated is the tundish lid 104′ with refractory 370 applied to each section 352a, 352b, 352c. FIG. 4C illustrates a top surface 104a (i.e., the cold side) of the tundish lid 104′, while FIG. 4D illustrates a bottom surface (i.e., the hot side) 104b of the tundish lid. In both FIGS. 4C and 4D a portion of each feed port 360a, 360b is covered by the refractory. The inlet ports 362a can be seen in FIG. 4C, while the outlet ports 364 can be seen in FIG. 4D. Access ports 106a-106d may be formed in the lid 104′ to enable viewing and/or access into the tundish without requiring lifting of the lid.

Accordingly, at least part of each feed port 360a, 360b is disposed in an interior space of the lid 104′. For example, the interior space may be defined as the region between a first surface of the support structure (e.g., the cold side), a second surface of the support structure (e.g., the hot side) disposed opposite the first surface, and side walls joining the first surface to the second surface.

In use, the tundish lid 104′ is installed on the tundish 102 and the input ports 362 are connected to a flux source via conduits as described herein. Flux then may be injected into the tundish 102 directly through the lid 104′ without the need of using an access port 106a-106d and without the need to rout conduit over the lid. This results in a cleaner installation with less chance of damage to feed components.

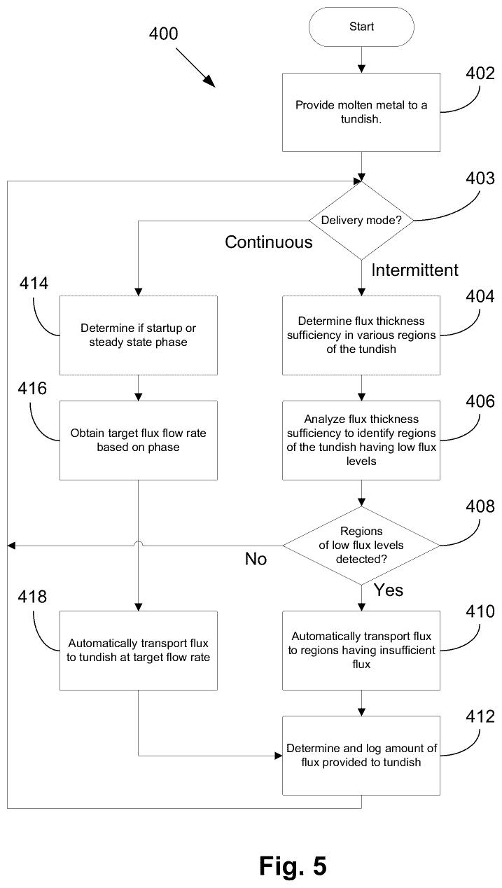

Referring now to FIG. 5 illustrated is a flow chart depicting steps of an exemplary method 400 for or automatically providing flux to a tundish during a metal-making process in accordance with the present invention. Variations to the illustrated method are possible and, therefore, the illustrated embodiment should not be considered the only manner of carrying out the techniques that are disclosed herein. Also, while FIG. 5 shows a specific order of executing functional logic blocks, the order of executing the blocks may be changed relative to the order shown and/or may be implemented in an object-oriented manner or a state-oriented manner. In addition, two or more blocks shown in succession may be executed concurrently or with partial concurrence. Certain blocks also may be omitted. The exemplary method may be carried out by executing code stored by an electronic device, for example. The code may be embodied as a set of logical instructions that may be executed by a processor of the controller 142. Therefore, the methods may be embodied as software in the form of a computer program that is stored on a computer readable medium, such as a memory.

Beginning at step 402, molten metal is provided to the tundish 102 via a series of ladles 108 in a conventional manner. The molten metal is transferred from the ladles 108 via a ladle shroud 110 disposed within an access port 106a of a tundish lid 104. At step 403 the controller 142 determines the operational mode of the system. More specifically, the controller 142 determines if the system is in a continuous transport mode in which flux is continuously transported to the tundish, or an intermittent transport mode in which flux is transported to the tundish on an as-needed basis. Determination of the operational mode may be based on, for example, a user input such as a selector switch or a graphical user interface.

If it is determined the system is in intermittent transport mode, the method moves to step 404 where sensor 140 monitors a surface of molten steel through the access ports 106a, 106b, 106c and/or the tundish lid 104 to collect data indicative of a flux layer thickness in the tundish 102, and the sensor 140 provides the data to controller 142. The controller 142 then analyzes the data to determine if various regions in the tundish 102 have a sufficient flux layer thickness (flux thickness sufficiency). Flux thickness sufficiency is a flag that indicates if a thickness of the flux layer in the tundish is sufficient or insufficient. If a thickness of the flux layer is insufficient (e.g., high heat loss detected in the region), then the flux layer thickness is deemed insufficient. Conversely, if the thickness of the flux layer is sufficient (e.g., low heat loss detected in the region), then the flux layer thickness is deemed sufficient.

For example, the controller 142 uses the data from the sensor 140 to form a heat signature of the molten steel in the areas around the access ports 106a, 106b, 106c. Hotter areas (e.g., areas with temperatures exceeding a preset threshold) would indicate an insufficient flux layer thickness, while colder areas (e.g., areas with temperatures below the present threshold) would indicate a sufficient flux layer thickness. The controller may compare the heat signature to a predetermined signature (or simply to a threshold value) to identify if excessive heat is present in certain regions of the tundish 102. Such excessive heat is indicative of thin flux layer and if detected, the controller 142 concludes there is insufficient flux. In determining the flux level sufficiency, the controller 142, at step 406, may divide the tundish 102 into multiple regions (sections) and, using the heat signature, associate a temperature or temperature range to each region. The controller 142 then determines if each region has a temperature/temperature range that is greater than a predetermined temperature threshold (or if some regions are higher than other regions) and, if so, that region is flagged as having insufficient flux. In forming the heat signature, the controller 142 may also quantify the temperature across the lid 104 to produce temperature gradients that indicate the temperature variation across the tundish lid 104.

Next at step 408 it is determined if any of the regions have been flagged for having insufficient flux. If no regions are flagged as having insufficient flux, then the method moves back to step 403 and repeats. However, if one or more regions are flagged as having insufficient flux, the method moves to step 410 and the controller 142 commands a material conveyor associated with the flagged region to transport flux over the molten metal in that region(s) of the tundish 102.

In the illustrated embodiments the flux is pneumatically transported, although other means of transport may be employed. Further, in transporting the flux the flow rate provided to the respective regions may be varied to produce a desired result. For example, two regions may have high temperatures, but one region may be significantly higher than the other. The controller 142 may command a first flow rate to the region with the higher temperature and a second flow rate to the region with the lower (but still excessive) temperature, where the first flow rate is greater than the second flow rate. The flux deposited in the region, in addition to trapping inclusions and preventing oxidation, acts as an insulation layer that reduces the amount of heat escaping from the tundish 102 and, thus, the sensor 140 will provide data indicative of a greater flux thickness (e.g., a temperature drop) for that region. The flow rate may be open loop control using the commanded flow rate and a known flow for a specified material conveyor speed and valve position, or closed loop control using the commanded flow rate and data from the flow sensors.

Next at step 412 the controller 142 may optionally determine a weight of flux deposited into the tundish 102 and/or a weight of the flux remaining in the flux storage area 128, 204. For example, the controller 142 may obtain data from sensor 144 that is indicative of a weight of the flux in the storage location and/or indicative of a change in weight in the storage location. Based on such data, the controller 142 can calculate how much flux has been transferred to the tundish 102 and how much flux remains in the bin 122, pressure chamber 206 and/or hopper 204. The method then moves back to step 403 and repeats.

Moving back to step 403, if the controller 142 determines the operational mode is continuous transport mode, then the method moves to step 414 and the controller 142 determines whether the steel-making process is in a startup phase (in which substantial flux is required to quickly cover the molten steel) or in a steady state phase (in which the system compensates for flux consumption). The phase of the system may be determined based on operator input using, for example, a graphical user interface, physical buttons and/or switches. Next at step 416 the controller 142 obtains a target delivery rate for the flux, where the target delivery rate is based on the operational phase of the system (startup or steady state). For example, if the system is in startup phase, the controller 142 may read a target delivery rate from one memory location, and if the system is in steady state phase the controller may read a target delivery rate from another memory location, where the values in the respective memory locations are preset or user-settable. Alternatively, one delivery rate may be preset for startup phase, and the delivery rate for steady state phase may simply be a preset fraction of the preset startup delivery rate. The method then moves to step 418 and the controller 142 automatically commands delivery of the flux to the tundish 102 at the specified delivery rate in a continuous manner. In this regard, the controller 142 may command the, air supply pressure, the venture units 123a, 123b, 123c and/or the valves 136a, 136b, 136c to operate in a manner that moves the flux into the tundish 102 at the desired delivery rate and at desired locations in the tundish. As discussed above, such control may be open loop control in which the flux delivery is based on the material conveyor speed and the valve positions, or closed loop control in which the system relies on sensors (e.g., weight sensors, flow sensors, optical sensors, etc.) to precisely control the amount of flux provided to the tundish. The method then moves to step 412 as discussed above.

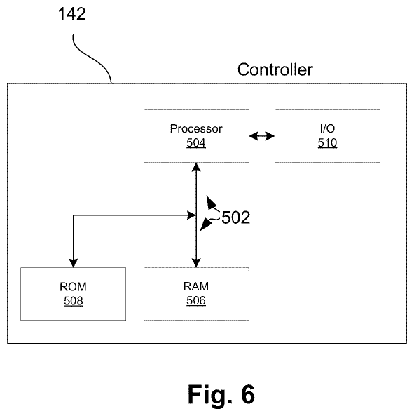

Referring now to FIG. 6, illustrated is a block diagram of an exemplary controller 142 for controlling operation of the flux transport system 100, 200. Although the controller 142 is illustrated being implemented as a processor executing software code, the controller 142 may take other forms. For example, the controller 142 may be implemented in hardware circuit(s) (e.g., an application specific integrated circuit) or a combination of a hardware circuit and a processor executing code. The controller 142 includes a bus 502 or other communication mechanism for communicating information, and a processor 504 coupled with the bus 502 for processing information. The controller 142 also includes a main memory 506, such as a random access memory (RAM) or other dynamic storage device, coupled to the bus 502 for storing information and instructions to be executed by the processor 504. The main memory 506 also may be used for storing temporary variables or other intermediate information during execution of instructions to be executed by the processor 504.

The controller 142 further includes a computer readable medium such as a read only memory (ROM) 508 or other static storage device coupled to the bus 502 for storing static information and instructions for the processor 504. The term “computer-readable medium” as used herein refers to any medium that participates in providing instructions to the processor 504 for execution. Such a medium may take many forms, including but not limited to, non-volatile media and volatile media. Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

The controller 142 further includes an input/output (I/O) module 510, including one or more of analog inputs/outputs, digital inputs/outputs, and/or communication ports (e.g., serial communication ports). The I/O module 510 enables the processor 504 to communicate with and/or control devices external to the controller 142, such as valves 136, sensors 140, 144, material conveyor 122, input port 124, compressor 208, or any other device of the system in which the controller 142 may supervise.

Accordingly, a device and method in accordance with the invention enables flux to be continuously or intermittently added to a tundish 102 without the need for an operator to physically move the flux into the tundish. Hence, an operator is not needed in the hazardous area around the tundish 102. Further, flux coverage of the molten metal is optimized due to less surface oxidation of the molten metal. This results in improved quality of steel with less internal defects.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

1. An apparatus for automatically loading flux into a tundish, comprising:
a transport including a material conveyor, wherein the material conveyor is configured to transport flux from a storage location to the tundish;
at least one first sensor configured to obtain data indicative of an amount of flux provided to the tundish; and
a controller operatively coupled to the at least one first sensor and to the transport, where in a first mode of operation the controller is configured to
obtain a target amount of flux to be provided to the tundish;
determine an actual amount of flux provided to the tundish based on data obtained by the first sensor, and
control the transport to provide flux to the tundish such that the actual amount of flux corresponds to the target amount of flux.

2. The apparatus according to claim 1, wherein the at least one first sensor is configured to measure at least one of an amount of flux transported by the material conveyor, or an amount of flux delivered into the tundish.

3. The apparatus according to claim 1, wherein the at least one first sensor comprises a strain gauge operative to provide data indicative of a change in flux weight at the flux storage location, and the controller is configured to determine a weight of flux transported by the transport based on the data provided by the at least one first sensor.

4. The apparatus according to claim 1, wherein the at least one first sensor comprises a flow sensor operative to provide data indicative of an amount of flux flowing into the tundish, and the controller is configured to determine a weight of flux transported by the material conveyor based on the data provided by the at least one first sensor.

5. The apparatus according to claim 1, further comprising at least one second sensor configured to obtain data corresponding to a thickness of flux layer in the tundish, where in a second mode of operation the controller is configured to control the transport based on the data corresponding to the flux layer thickness to transport flux to a desired location in the tundish.

6. The apparatus according to claim 5, wherein the at least one second sensor comprises a camera.

7. The apparatus according to claim 6, wherein the camera comprises a thermal imaging camera.

8. The apparatus according to claim 1, wherein the controller is configured to enable or disable the material conveyor.

9. The apparatus according to claim 1, wherein the transport comprises a pneumatic transport.

10. The apparatus according to claim 1, wherein the material conveyor utilizes a Venturi to transport the flux to the tundish.

11. The apparatus according to claim 1, wherein the material conveyor applies pneumatic pressure to transport the flux to the tundish.

12. The apparatus according to claim 1, further comprising a hopper for storing flux, the hopper coupled to the material conveyor.

13. The apparatus according to claim 1, further comprising one or more conduits coupled to the material conveyor, and at least a portion of each of the one or more conduits is flexible to enable a respective one or more conduits to be routed to a target location in the tundish.

14. The apparatus according to claim 1, wherein the controller is configured to control the material conveyor to provide a first flow rate of flux to a first region in the tundish and a second flow rate of flux to a second region in the tundish, the second flow rate different from the first flow rate.

15. The apparatus according to claim 1, further comprising a tundish lid for covering the tundish, the tundish lid having at least one feed port integrally formed within the tundish lid, the at least one feed port having an input port for receiving flux from the material conveyor, at least one output port for outputting flux into the tundish, and a conduit fluidically coupling the input port to the at least one output port.

16. A method for automatically providing flux to a tundish during a metal-making process, comprising:
during a first mode of operation determining a target amount of flux to be provided to the tundish;
determining an actual amount of flux provided to the tundish; and
using a pneumatic transport to deliver the flux to the tundish such that the actual amount of flux corresponds to the target amount of flux.

17. The method according to claim 16, wherein using the pneumatic transport to deliver the flux includes at least one continuously delivering the flux to the tundish or intermittently delivering the flus to the tundish.

18. The method according to claim 16, further comprising during a second mode of operation determining flux thickness sufficiency on a top surface in the tundish;
identifying, based on the flux thickness sufficiency, regions of the top surface of the tundish that have insufficient flux; and
automatically transporting flux to the identified regions of the top surface of the tundish.

19. The method according to claim 18, wherein determining the flux thickness sufficiency includes determining a rate of heat loss from each of the regions, and concluding regions that are losing heat at a rate above a predetermined threshold have insufficient flux layer thickness.

20. The method according to claim 18, wherein determining the flux thickness sufficiency comprises obtaining a heat signature for a top surface of the flux in the tundish and determining the flux thickness sufficiency based on the heat signature.

21. The method according to claim 20, wherein obtaining the heat signature comprises obtaining a thermal image of the top surface of the flux through an access port in the tundish.

22. The method according to claim 20, wherein identifying includes analyzing the heat signature to quantify heat loss over the top surface of the flux.

23. The method according to claim 16, wherein delivering the flux to the tundish includes automatically transporting the flux to a first region at a first flow rate, and automatically transporting the flux to a second region at a second flow rate different from the first flow rate.

24. The method according to claim 16, further comprising determining a weight of flux provided to the tundish.

25. The method according to claim 16, wherein delivering flux includes pneumatically transporting the flux to the identified regions.

26. An apparatus for automatically loading flux into a tundish, comprising:
a transport including a material conveyor and one or more outlets fluidically coupled to the material conveyor, wherein the material conveyor is configured to transport flux from a storage location to the one or more outlets;
at least one sensor configured to provide data indicative of i)_an amount of flux provided to the tundish or ii) insulative properties of a layer of flux in the tundish; and
a controller operatively coupled to the at least one sensor and to the transport, where the controller is configured to
determine, based on data provided by the sensor, if the tundish requires flux, and
if flux is required, control the transport to provide flux to the tundish.

27. A tundish lid for selectively covering a top surface of a tundish, comprising:
a support structure having a first surface, a second surface disposed opposite the first surface, and a at least one side wall joining the first surface to the second surface;
at least one feed port including an input port for receiving flux, an output port for outputting flux into the tundish, and a conduit fluidically coupling the input port to the output port,
wherein the at least one feed port is at least partially disposed between the first surface, the second surface, and the at least one sidewall.

28. The tundish lid according to claim 27, wherein the input port opens to the first surface and the output port opens to the second surface.

29. The tundish lid according to claim 27, wherein the support structure comprises a metal frame and at least one of a wire mesh or metal anchors attached to the metal frame.

30. The tundish lid according to claim 29, further comprising refractory attached to the at least one of the wire mesh or the metal anchors.
